(19) United States
(12) Patent Application Publication
(10) Pub. No.: US 2008/0099619 A1
(43) Pub. Date: May 1, 2008

(54) Fuel system - aircraft (fuel quantity indicating and delivery systems)

(76) Inventor: John Anthony Diaks, Bonney Lake, WA (US)

Correspondence Address: John Anthony Diaks, 10801 176 Avenue East, Bonney Lake, WA, 98391, US

(21) Appl. No.: 11/588,887

(22) Filed: Oct. 30, 2006

(51) Int. Cl. B64D 37/32

(52) U.S. Cl. 244/135 R

(57) ABSTRACT

The system and method of the present concept is to provide a significantly reduced electrically dependent fuel system, thus reducing a combustible environment with a reduction in the consumption of electrical power. Manufacturing costs and weight savings can be realized with the need for a costly and weighty inert gas installation or pressurization system is eliminated.

### BACKGROUND OF CONCEPT

Conclusions, rightly or wrongly, that an electrical spark, internal to a fuel tank caused an explosion to occur and to have caused, TWA (Trans World Airlines) flight 800, to explode and disintegrate in-flight.

The basis for this concept/idea is the result of those conclusions. and to preclude events of that type of ever occurring again by the removal of electrical components from aircraft fuel tanks. Those units include, FUEL TANK MEASURING UNITS, FUEL TANK COMPENSATORS and FUEL PUMPS. In addition to creating an almost electrical free fuel tank environment, removal of these units will create a weight saving as well.

Aircraft, whether general aviation, business or commercial, past, present or future, can be retrofitted or designed to incorporate this fuel system concept, either in total or in part.

### SUMMARY OF CONCEPT

As previously stated, this fuel system, whether in part or in total can be implemented to retrofit existing aircraft or to be designed into future aircraft using CONDENSED LIGHT BEAM (LASER) equipment and PRESSURE DIFFERENTIAL/VACUUM FUEL PUMPS (JET PUMPS).

This idea/concept would essentially remove approximately 99 percent of the existing electrical components, associated with the fuel quantity indicating system and fuel delivery system presently employed onboard current and future aircraft.

With the possibility of one or two of the existing units already in use and removing the remaining units, a considerable weight savings would be realized.

### BRIEF DESCRIPTION OF DRAWINGS

FIG. 1 illustrates a simplified functional schematic of the fuel quantity system as a proposed concept to maximize the removal of electrical units from within the fuel tanks while still maintaining fuel quantity indicating accuracy and reliability.

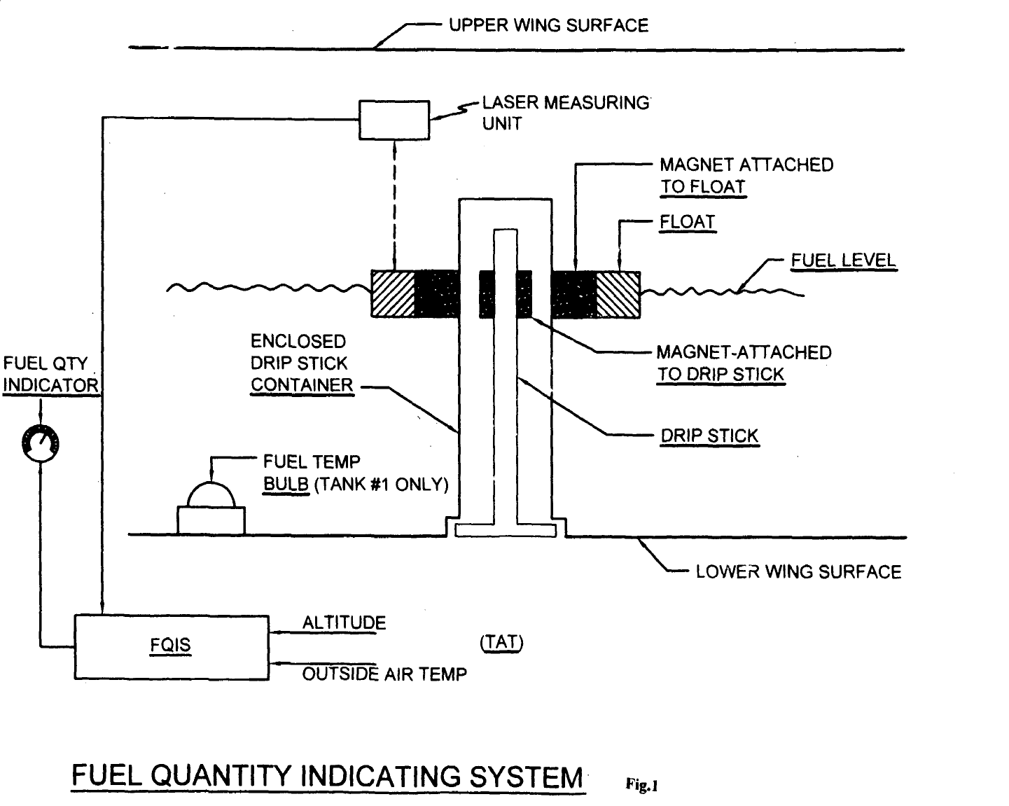

FIG. 2 illustrates a simplified functional schematic of the fuel delivery system as a proposed concept to maximize the removal of fuel delivery pumps and to maximize fuel availability for engine consumption, in all regimes of flight and also as a means for pressurizing (to some degree) the fuel tanks thus reducing the fuel flash point. This then will negate the need for installing heavy, inert gas generating equipment.

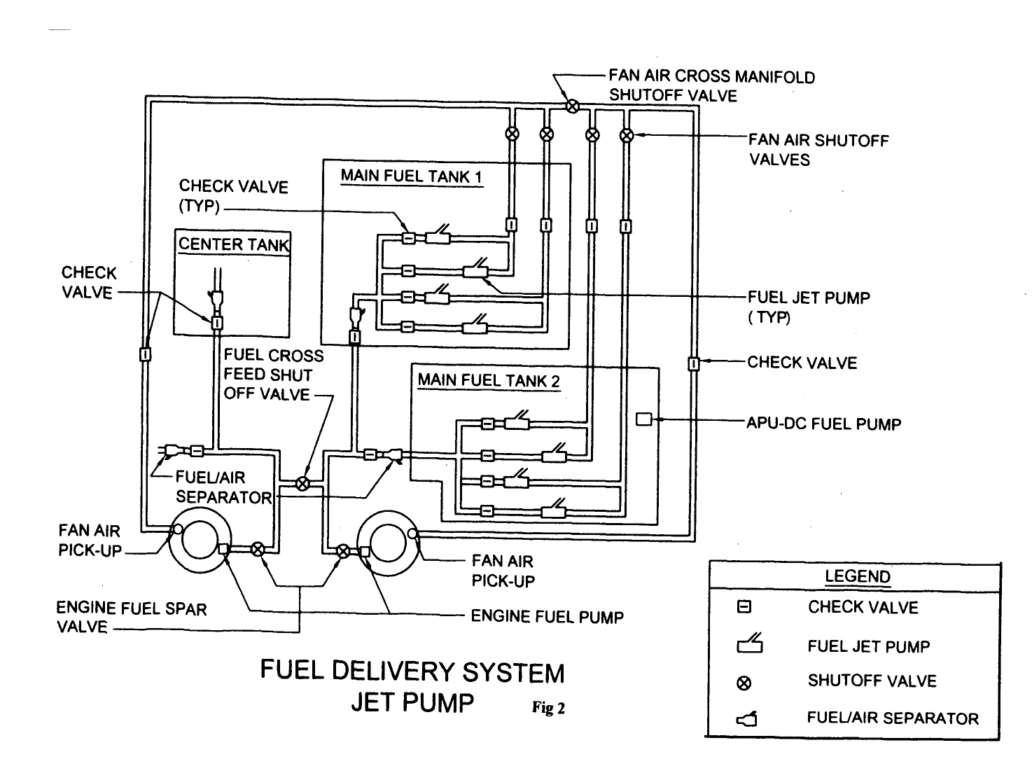

### DETAIL DESCRIPTION

The usefulness of this type of a fuel system concept is manifested in two distinct and basic configurations. The first being a stand alone fuel quantity system that:

### 1. The following existing components would remain at their present locations on present day aircraft (when modifying these aircraft) and where fuel system engineering dictates they should be on future aircraft.

a) Fuel sticks with their associated canisters and donut floats. Fuel measurement sticks and floats to retain their magnets.
b) Fuel temperature bulb, located in main tank number one on Boeing airplanes or in any other inboard main tank.
   2. The fuel quantity indicating system is to use fiber optic wiring to supply power and to transmit data to/from a laser/condensed light beam measuring unit. These laser/condensed light beam units would be located and attached to, the under side of the wing surface inside the fuel tanks. Laser/condensed light measuring units are to be mounted directly above donut shaped floats, which, on current model airplanes (Boeing in particular), are installed around an enclosed cylinder containing a fuel measuring stick (drip stick). The float moves up and down the outside of the canister as the level of fuel increases or decreases. On current and future model aircraft and as engineering dictates, measuring sticks and canisters are to be located at various locations throughout a fuel tank. The laser/condensed light beam unit directs its beam to the top of the float. As the level of fuel in a tank, increases or decreases, the laser beam measures this changing distance (from the top of the tank to the top of the float, which is floating on top of the fuel). Note: This measurement is the reverse measurement of what is currently being used to calculate the amount of fuel (in a fuel tank) using the “drip stick” measurement method on the ground. Instead of measuring the height of fuel in a tank from the bottom of the tank to the float, the laser method will measure the distance from the laser unit at the top of the tank to the top of the float.
   3. With the laser/condensed light beam unit mounted directly above the floating donut shaped float, (at each measurement (drip) stick location), located throughout a fuel tank, directs its beam to the top of the float. This distance is then measured by the laser unit. This distance measurement information is then transmitted to the fuel quantity indicating (FQIS) computer. The fuel quantity indicating computer will then determine the amount of fuel at that location and at the other similar locations. Through summing circuitry, the fuel quantity computer will calculate the total amount of fuel in that particular fuel tank. This is similar to determining fuel “on board”, when the airplane is on the ground manually.
   4. On current model airplanes (Boeing in particular), the reverse of the proposed fuel laser measurement already exists. Fuel height measurement, along with fuel density (specific gravity) is currently used to determine fuel quantity.
   5. In determining fuel quantity, a fuel temperature sensor can be installed inside a fuel tank. On current Boeing aircraft models, there already exists a temperature sensor/bulb. This temperature sensor is located inside the number one main fuel tank.

### 6. From other existing aircraft systems, aircraft altitude and outside air temperature, along with the fuel temperature, can be sent to the fuel quantity indicating system computer to determine fuel density.

The second application is also that of a stand alone fuel delivery system.

1. The fuel delivery system, as it is identified in modern day aircraft, use electric fuel (Boost) pumps to deliver fuel to the engines. The proposed concept would remove all the existing electric fuel boost pumps. The possible exception would be that of the electric pump used by the Auxiliary Power Unit (APU), on those airplanes that have an Auxiliary Power Unit installed. By eliminating the use of electric fuel boost pumps and their associated access panels a weight savings is realized. Also realized is construction cost savings by not having to install these access panels on the underside of the wing.
2. Briefly, the proposed concept is to use pressure differential or vacuum fuel pumps (Jet Pumps). The installed pressure differential or vacuum fuel pumps can be located in the same locations as on current model airplanes or where dictated by engineering on future model airplanes. These pressure differential or vacuum fuel pumps can be scattered throughout a fuel tank to be used as scavenge pumps.
3. The principle behind a pressure differential or a vacuum fuel pump is to have a motive force of either hydraulic or pneumatic fluids and create a vacuum to pick up either a hydraulic or a pneumatic fluid. The motive force behind this concept is air.
a) This air can be obtained from several sources. These sources on a jet engine being jet engine fan air. Fan Air is that air taken from the inside the engine fan duct. This Fan Air (if necessary) may be cooled by a heat exchanger. This Fan Air take-off port, may need to be sized to prevent over pressurizing a fuel tank.
b) Engine bleed air. This bleed air is bled off upstream of the engine bleed air shutoff valve and cooled, if necessary, prior to being used in the fuel delivery system.
c) Or possibly the use of one or two interconnected electric air pumps.

The preferred method would be the use of jet engine's fan air.

4. Whatever the air source, for the pressure differential or vacuum fuel pumps, fuel under pressure is not required to start an engine. Case in point. When doing a battery start. A battery start is done when there is no electrical AC power available to start an engine and only pneumatic power is available to supply the pneumatic duct. Battery DC power is used to open the engine fuel shutoff valve to allow gravity (initially), to supply to the engine fuel pump and the engine pneumatic start valve, to supply pneumatic pressure to the engine starter.
5. Whenever doing an engine battery or a normal start, the start valve is opened. This then, will cause the engine to start to rotate. As the engine starts to rotate, air (fan air) begins to flow through the engine. At this point, fan air becomes the motive force comes into effect. This fan air pressure may have to be pressure regulated and cooled.
6. AS the air (fan air) picks up the fuel, via the pressure differential or vacuum fuel pumps, there becomes a mixture of fuel and air. This fuel and air mixture can be separate by a FUEL/AIR SEPARATOR. This FUEL/AIR SEPARATOR, is in principle, similar to the water separator, already in existing in the air conditioning system, aboard current model airplanes, but on a smaller scale. Another method of separating the fuel air mixture is by using “Centercept Filter.”
7. The operation of the FUEL/AIR SEPARATOR is that as the fuel and air mixture passes through the unit, it passes across air-foiled stator vanes. The stator vanes will cause the fuel/air mixture to swirl. Through centrifugal action and fuel being heavier than air, the fuel would be slung outward, to the outer reaches of the separator, through a perforated shell. The centercept filter basically operates on the same principle. With the fuel still under pressure, it can then be directed to the engine fuel system, (engine fuel pump and engine fuel control unit).
8. The air, from the fuel/air mixture that has passed through the FUEL/AIR SEPARATOR, is now devoid of fuel and can be dumped into the fuel tank. This air can then possibly pressurize the fuel tank to some degree, reducing the need of expensive inert gas systems from being installed.

I claim:

1. The concepts identified herein would not only drastically remove electrical units from within a potentially explosive fuel vapor environment, but produce manufacturing cost savings, an overall weight savings and a reduction in electrical power consumption. When the combined fuel/air mixture is mechanically separated, the air is dumped into the fuel tank. This air would then cause a positive head pressure upon the fuel within the tank, thus effectively reducing the flash point of the fuel.
